(19) United States
(12) Patent Application Publication
(10) Pub. No.: US 2016/0174139 A1
(43) Pub. Date: Jun. 16, 2016

(54) RANGING PROFILING FOR NEIGHBOR AWARENESS NETWORKING

(71) Applicant: Intel Corporation, Santa Clara, CA (US)

(72) Inventors: JONATHAN SEGEV, Tel Mond (IL); EMILY H. QI, PORTLAND, OR (US)

(73) Assignee: Intel Corporation, Santa Clara, CA (US)

(21) Appl. No.: 14/572,586

(22) Filed: Dec. 16, 2014

(51) Int. Cl. H04W 48/16

(52) U.S. Cl. CPC H04W 48/16

(57) ABSTRACT

Disclosed herein are techniques to augment connection capability and service discovery in a neighbor awareness networking with ranging profiling. In particular, a service discovery frame is disclosed, the service discovery frame including an indication of a ranging protocol. The service discovery frame can include an indication of a ranging mode and an operational environment for the ranging mode.

### TECHNICAL FIELD

Embodiments described herein generally relate to wireless communications and in particular to profiling for ranging with neighbor awareness networking.

### BACKGROUND

Many modern devices include networking capabilities. In particular, many devices include various communication and networking abilities. Modern applications are beginning to take advantage of this and provide for interconnectivity of such devices. For example, social networking applications, Internet of Things, wireless docking, etc. may provide for the interconnectivity of various devices. A variety of standards are used and/or proposed to facilitate such device connectivity. For example, Wi-Fi Direct, peer-to-peer, neighbor awareness networking, proximity discovery, or the like.

The Wi-Fi Alliance (WFA) has developed a protocol referred to as Neighbor Aware Networking (NAN). NAN facilitates device-to-device service discovery among various Wi-Fi enabled devices. In general, NAN allows multiple Wi-Fi devices to be synchronized such that the devices can communicate for purposes of sharing and/or discovering services.

Service discovery can be augmented by range measurements to provide proximity, positioning, and location information. However, the scheduling and operation environment for range measurements can differ based on the mode in which service discovery takes place. For example, finite timing measurements can differ based on NAN mode, infrastructure mode, or the like.

### BRIEF DESCRIPTION OF THE DRAWINGS

FIG. 1 illustrates one embodiment of a peer-to-peer network.

FIG. 2 illustrates one embodiment of connectivity capability information.

FIG. 3 illustrates one embodiment of remote wakeup information.

FIGS. 4-5 illustrate logic flows for embodiments of connectivity capability discovery and remote wakeup.

FIG. 6 illustrates one embodiment of a remote discovery and wakeup technique.

FIG. 7 illustrates one embodiment of a storage medium.

FIG. 8 illustrates one embodiment of a device.

FIG. 9 illustrates one embodiment of a wireless network.

### DETAILED DESCRIPTION

The present disclosure is generally directed to profiling ranging capabilities for neighbor aware networking (NAN) to provide an indication of supported ranging profiles. For example, NAN provides a protocol for devices to pre-associate for purpose of service discovery. This service discovery can be augmented by range measurements to provide proximity, positioning, and location support. As such, devices can associate services to, for example, perform file transfer when two devices are in the same room, select a particular device to associate with based on proximity, or the like.

However, performing ranging (e.g., the procedure, scheduling, operational environment, etc.) can differ based on the mode of communication (e.g., NAN mode, infrastructure mode, or the like). For example, finite time measurement (FTM) procedure execution in NAN mode requires an FMT initiator to FTM responder ratio of 1 to N and operation on the same channel; while infrastructure mode requires an FMT initiator to FTM responder ratio of N to 1 and multi-channel operation. Other range measurement procedures may differ as well, for example, scan operations can differ for NAN and infrastructure mode.

Accordingly, the present disclosure provides a NAN ranging attribute that includes an indication of supported ranging profiles. In general, the present disclosure provides a service discovery frame to include an indication of the ranging profile the service discovery frame supports. Additionally, the service discovery frame can include an indication of the operating environment for the ranging protocol.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

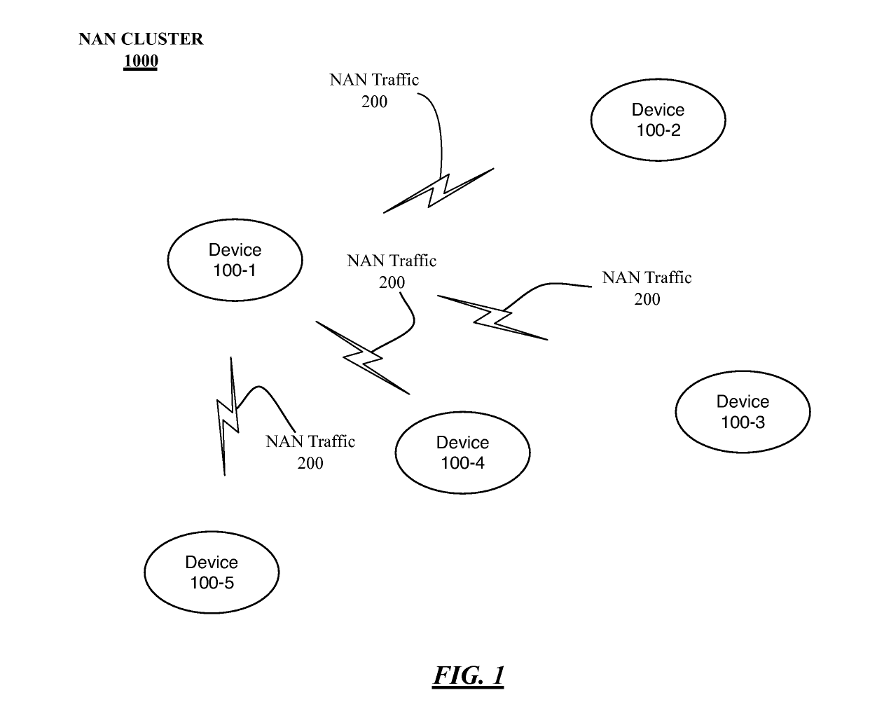

FIG. 1 illustrates a NAN cluster 1000. The NAN cluster 1000 includes devices 100-a, where “a” is a positive integer. In particular, devices 100-1 to 100-5 are shown. However, it is to be appreciated, that any number of devices 100-a may be implemented, and the number of devices depicted is merely shown at a quantity to facilitate understanding.

In some examples, the NAN cluster 1000 may be implemented according to various standards or technical specifications. In particular, the NAN cluster 1000 may be implemented according to standards promulgated by the Wi-Fi Alliance (WFA). For example, the NAN cluster 1000 may be implemented according to the WFA standard for Neighbor Awareness Networking entitled “Wi-Fi Peer-to-Peer (P2P) Technical Specification,” v 1.5, 2014 or implemented according to the WFA standard for Hotspot entitled “Hotspot 2.0 Technical Specification,” release 2, 2014.

In general, the devices 100-a in the NAN cluster 1000 may communicate with each other (e.g., wirelessly, or the like) via signals, represented as NAN traffic 200, to advertise and/or identify services available within the NAN cluster. For example, the devices 100-a may transmit signals including indications of connectivity capabilities (Wi-Fi, Wi-Fi Direct (WFD), infrastructure, independent basic service set (IBSS), Ad-hoc, or the like) and services (e.g., print services, file sharing services, media streaming services, or the like). With some examples, ones of the devices 100-a may advertise available connection capabilities and/or services. With some examples, ones of the devices 100-a may request or solicit connection capabilities and/or services. With some examples, ones of the devices 100-a may both advertise and solicit connection capabilities and/or services.

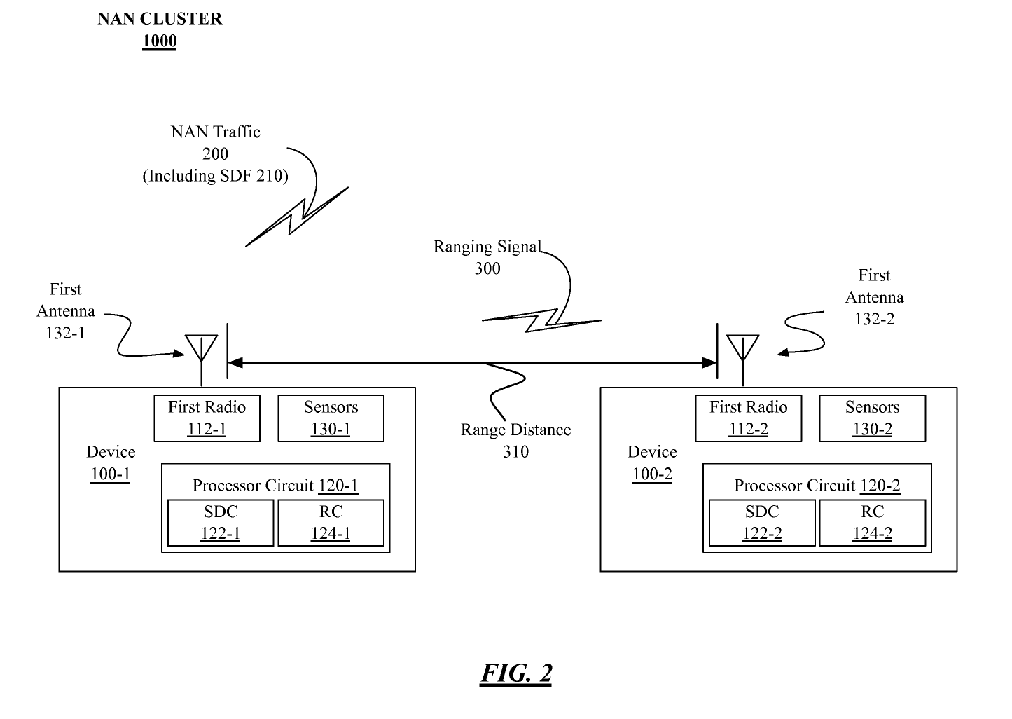

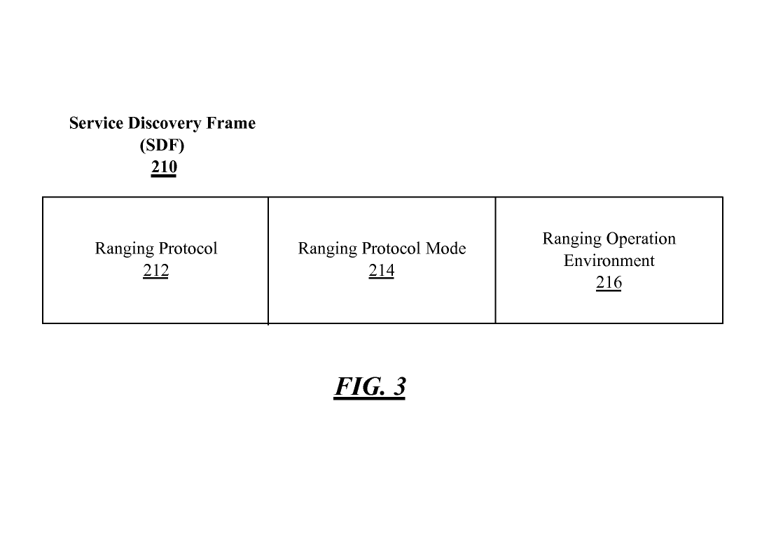

In general, devices 100-a may advertise and/or solicit connection capabilities and/or services using a service discovery frame (SDF) (refer to the SDF 210 of FIGS. 2-3). In particular, the devices 100-a may transmit and/or receive SDFs (e.g., as part of NAN traffic 200, or the like) to advertise and solicit connection capabilities and/or services to/from the other devices 100-a in the NAN cluster 1000. Said differently, the NAN traffic 200 may comprise SDFs to include indications of connection capabilities and services available within the NAN cluster 1000. Additionally, the SDFs can include an indication of a ranging protocol. More particularly, the SDFs may include an indication of a particular ranging profile that is supported and may further include an indication of the operational environment associated with the ranging profile.

As such, the present disclosure provides connection capability and service discovery available within the NAN cluster 1000, augmented with ranging or “proximity” profiling. More specifically, devices 100-a within the NAN cluster 1000 can advertise and/or identify connection capabilities and/or services available within the NAN cluster 1000 and utilize such services based on proximity to the device advertising the service. For example, if the devices 100-3 and 100-4 advertise the same service (e.g., media streaming, or the like) the device 100-1 may select to use the device 100-4 based on determining that the device 100-4 is closer in proximity to the device 100-1 than the device 100-3 is.

The present disclosure provides that multiple different ranging protocols may be supported within the NAN cluster 1000. In particular, by augmenting the SDF to include an indication of the supported ranging profile, multiple different ranging protocols may be supported. For example, according to the present disclosure, one of the devices 100-a may be an Access Point (AP) advertising AP location services using finite time measurement (FTM); while another of the devices 100-a may be a Wi-Fi Direct (WFD) capable device advertising WFD authentication proximity; while still another of the devices 100-a may advertise FTM using the unprotected and unassociated mode of NAN. It is noted, that these examples are provided for purposes of clarity and explanation only and are not intended to be limiting. Instead, the present disclosure is to be understood to facilitate a NAN cluster (e.g., the NAN cluster 1000) to support more than one type of ranging protocol. As such, various types of ranging (e.g., NAN ranging, WFD ranging, infrastructure ranging, IBSS ranging, or the like) can be supported within a single NAN cluster.

FIG. 2 illustrates a block diagram of an embodiment of a portion of the NAN cluster 1000 of FIG. 1. In particular, FIG. 2 illustrates the device 100-1 and 100-2 receiving an SDF frame 210 including an indication of a supported ranging protocol as described herein.

The devices 100-1 and 100-2 can include a radio. For example, the device 100-1 is depicted including the radio 112-1 while the device 100-2 is depicted including the radio 112-2. In general, the radios 112-1 and 112-2 may be any radio configured to communicate wireless (e.g., to transmit and receive NAN traffic 200). For example, the radio 112-1 and 112-2 may be Wi-Fi radios, WiGig radios, Bluetooth radios, ZigBee radios, or the like. Furthermore, the devices 100-1 and 100-2 can includes an antenna (or antenna array). For example, the device 100-1 is depicted including the antenna 132-1 while the device 100-2 is depicted including the antenna 132-2. The antennas 132-1 and 132-2 are operably connected to the radio 112-1 and 112-2, respectively. Additionally, it is to be appreciated, that although not depicted, ones of the devices 100-1 and 100-2 may be provided with additional radio(s) and/or antennas.

Additionally, the devices 100-1 and 100-2 include a processor circuit 120-1 and a processor circuit 120-2, respectively. The processor circuits 120-1 and 120-2 are operably coupled to the radios 112-1 and 112-2, respectively. In some examples, the processor circuits 120-1 and/or 120-2 may be an application processor of the device. In some examples, the processor circuits 120-1 and/or 120-2 may be a baseband processor of the device. The devices 100-1 and 100-2 may also include a service discovery component 122-1 and 122-2, respectively. The service discovery components are referred to as “SDC 122-a” in the figures. Furthermore, the devices 100-1 and 100-2 may also include a ranging component 124-1 and 124-2, respectively. The ranging components are referred to as “RC 124-a” in the figures. The service discovery components 122-1 and 122-2 and the ranging components 124-1 and 124-2 may comprise programming, functions, logic, parameters, and/or other information operative to implement particular capabilities for the devices 100-1 and 100-2. In some examples, the components 122-1/124-1 and 122-2/124-2 may be executable by the processing circuits 120-1 and 120-2, respectively.

In general, the service discovery components 122-1 and 122-2 may be configured to transmit and receive SDFs 210 (e.g., refer to FIG. 3) via the radios and antennas (e.g., 112-1/132-1 and 112-2/132-2) as part of NAN traffic 200. The SDFs 210 may be used to advertise and solicit connection capabilities and services as well as to indicate a supported ranging protocol and ranging operational environment. In particular, the service discovery components 122-1 and 122-2 may be configured to generate and transmit or receive the SDFs 210. The SDFs 210 may comprise an indication of a ranging protocol (e.g., mode, or the like) and an operational environment. With some examples, the ranging protocol may comprise infrastructure mode (e.g., AP to station (STA), or the like), NAN mode (e.g., STA to STA, or the like), WFD mode (e.g., associated STA to STA, or the like), or IBSS mode. With some examples, the operational environment may comprise an indication that the STA (e.g., the device 100-1, the device 100-2, or the like) is an FTM responder, the STA is an FTM initiator, the STA is proximity capable, the STA is geo-location capable, or the STA is civic location capable.

The ranging components 124-1 and 124-2 may be configured to communicate a ranging signal 300 to determine a range distance 310 (e.g., an approximate distance between the devices 100-1 and 100-2, or the like) for purposes of proximity based services. It is noted, that various ranging and proximity based services are described in greater detail in, for example, the standards referenced above.

FIG. 3 illustrates an example SDF 210, which may be communicated by one of the devices 100-a using the radio 112-a to advertise or solicit connectivity capabilities and services as well as to indicate supported ranging protocols as described herein. In some examples, the SDF 210 may be a publish SDF or a subscribe SDF. In particular, the SDF 210 may be a publish SDF or a subscribe SDF formatted according to one or more NAN specifications, for example, the specifications referenced above.

The SDF 210 can include various information elements to include indications of a supported ranging protocol. For example, FIG. 3 depicts the SDF 210 including a ranging protocol information element 212, a ranging protocol mode information element 214, and a ranging operation environment 216. In some examples, the information elements 212, 214, and 216 can be fields, bit maps, or the like, set to indicate information about a ranging protocol. It is to be appreciated, that in some examples, the information elements (e.g., 212, 214, 216, or the like) may be contiguously located in the SDF frame 210. Furthermore, it is to be appreciated, that the example implementation shown in FIG. 3 along with the table described below are given for convenience and clarity of presentation and are not intended to be limiting. Furthermore, additional information elements may be included in the SDF 210, which are not shown in FIG. 3. For example, the SDF 210 may include indications of supported connection capabilities and services, or the like.

| Information | Size | | |
|---|---|---|---|
| Element | (Octets) | Value | Description |
| Ranging | 1 | Variable | 0: Denotes FTM |
| Protocol | | | 1-255: Reserved |
| Ranging | 1 | Variable | 0: Infrastructure Mode (AP to STA) |
| Protocol | | | 1: NAN Mode (STA to STA) |
| Mode | | | 2: WFD Mode (Associated STA to |
| | | | STA) |
| | | | 3: IBSS Mode |
| | | | 4-255: Reserved |
| Ranging | 1 | Variable | Bit 0: STA is an FTM Responder |
| Operation | | | Bit 1: STA is an FTM Initiator |
| Environment | | | Bit 2: STA is proximity Capable |
| | | | Bit 3: STA is Geo-Location Capable |
| | | | 4: STA is Civic Location Capable |
| | | | 5-7: Reserved |

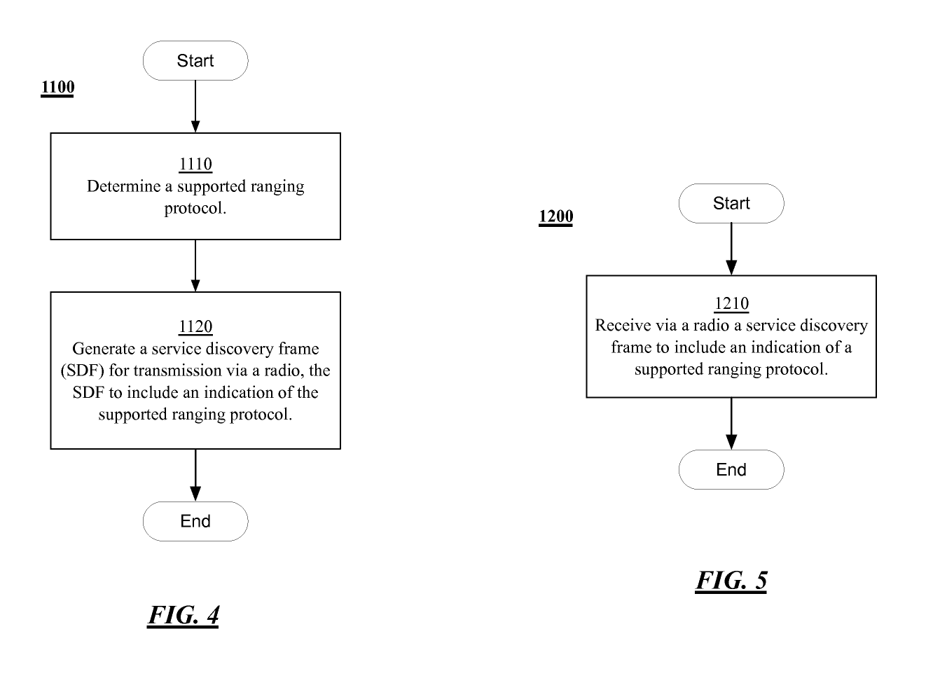

FIGS. 4-5 illustrates an examples of logic flows representative of at least some operations executed by one or more logic, features, or devices described herein. In general, the logic flow may be representative of some or all of the operations executed by logic and/or features of the devices 100-a of the NAN cluster 1000. In particular, the logic flows 1100 and 1200 depicted in these figures may be representative of operations performed by the devices 100-1 and/or 100-2 in advertising or soliciting connectivity capabilities and services while providing an indication of supported ranging protocols. It is to be appreciated, that although the example logic flow is described with reference to the NAN cluster 1000 and particularly the device 100-1 of FIGS. 1-2 and the SDF 210 of FIG. 3, this is not intended to be limiting and is merely done for clarity of presentation.

Turning more specifically to FIG. 4, logic flow 1100 may begin at block 1110. At block 1110, “determine a supported ranging protocol” the device 100-1 may determine a supported ranging protocol. In particular, the service discovery component 122-1 may determine a ranging protocol supported by the device 100-1. For example, the service discovery component 122-1 may determine a ranging protocol supported by the ranging component 124-1.

Continuing to block 1120, “generate a service discovery frame to include an indication of the ranging protocol” the device 100-1 may generate the SDF 210. In particular, the service discovery component 122-1 may generate the SDF 210 to include indications of the determined ranging protocol, for example, the information elements 212, 214, and 216.

Turning more specifically to FIG. 5, a logic flow 1200 is depicted. The logic flow 1200 may begin at block 1210. At block 1210, “receive, via a radio, a service discovery frame to include an indication of a ranging protocol” the device 100-2 may receive via the radio 112-2 the SDF 210 including an indication of a supported ranging protocol. In particular, the service discovery component 122-2 may receive the SDF 210 (e.g., via the radio 112-2 and the antenna 132-2) including the information elements 212, 214, and 216. Said differently, the service discovery component 122-2 may receive the SDF 210 (e.g., from the device 100-1) to include an indication of the ranging protocol supported by the device 100-1.

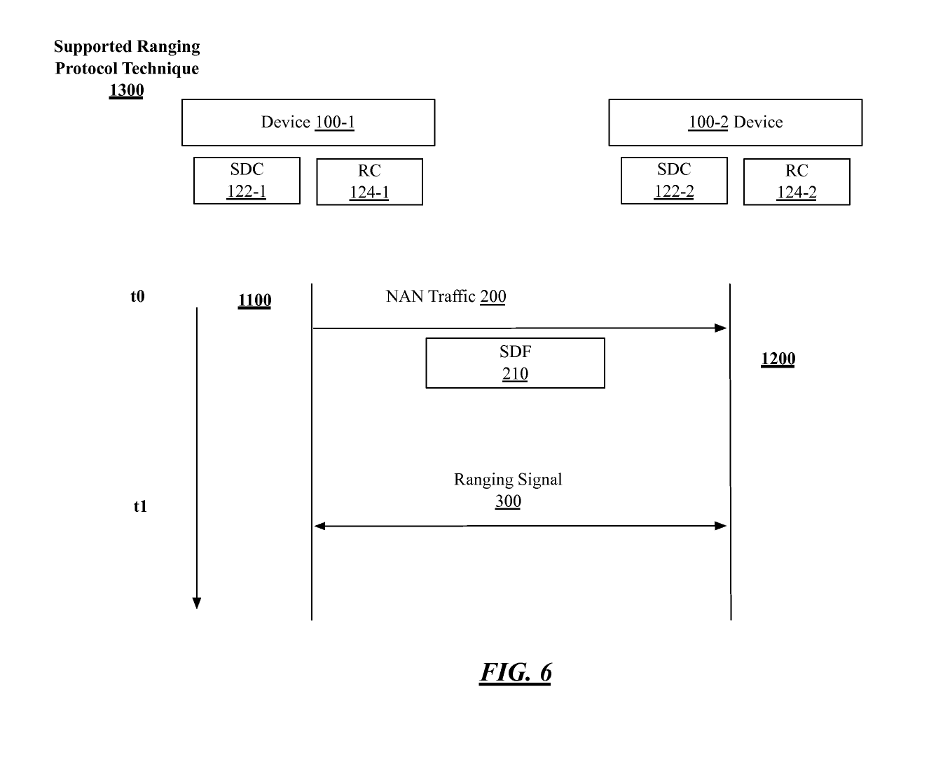

FIG. 6 illustrates an example technique 1300 for indicating supported ranging protocol conducting ranging based on the indicated protocol. In some examples, the devices 100-a can implement the technique. In particular, the acts depicted in the technique may be representative of a technique such as may be performed in various embodiments of the present disclosure. More particularly, the technique may be representative of indicating supported ranging protocols during service discovery within a NAN cluster and conducting ranging based on the indicated supported ranging protocol.

In the technique 1300, communications are exchanged between the devices 100-1 and 100-2. In general, a device (e.g., the device 100-1) may advertise supported connectivity capabilities and services and indicate a supported ranging protocol by communicating an SDF including information elements. Additionally, a device (e.g., the device 100-2) may identify a supported ranging protocol (e.g., based on receiving supported ranging information, or the like) and initiate ranging to determine proximity to the device 100-1, or the like.

In particular, the technique 1300 shows the device 100-1 communicating the SDF 210, for example, as part of NAN traffic 200 to advertise connectivity capabilities, supported services, and to indicate a supported ranging protocol. In some examples, the service discovery component 122-1 can determine the ranging protocol supported by the device 100-1 and generate the SDF 210 to include an indication of the determined ranging protocol. For example, the service discovery component 122-1 can generate the SDF 210 to include the information elements 212, 214, and 216. Additionally, the service discovery component 122-1 can communicate the SDF 210 (e.g., as part on NAN traffic 200). Said differently, the service discovery component 122-1 may conduct operations consistent with the logic flow 1100 to generate and communicate the SDF 210 including indications of the supported ranging protocol.

The device 100-2 can receive the SDF 210 and determine the ranging protocol supported by the device 100-1. In particular, the service discovery component 122-2 can receive the SDF 210 (e.g., as part of NAN traffic 200) and determine the supported ranging protocol from information elements (e.g., the information elements 212, 214, and 216) in the SDF 210. Said differently, the service discovery component 122-2 may conduct operations consistent with the logic flow 1200 to receive the SDF 210 and determine a supported ranging protocol based on the SDF 210.

Furthermore, the devices 100-1 and 100-2 can engage in ranging using the supported ranging protocol. More specifically, the devices 100-1 and 100-2 can communicate ranging signals 300 to determine the proximity of the devices 100-1 and 100-2 based on the supported ranging protocol. For example, the SDF 210 may indicate that the supported ranging protocol is WFD FTM. As such, the devices 100-1 and 100-2 can engage in ranging by communicating ranging signals 300 in accordance with a WFD FTM procedure. In some examples, the SDF 210 may indicate that the supported ranging protocol is FTM NAN. As such, the devices 100-1 and 100-2 can engage in ranging by communicating ranging signals 300 in accordance with an FTM NAN procedure.

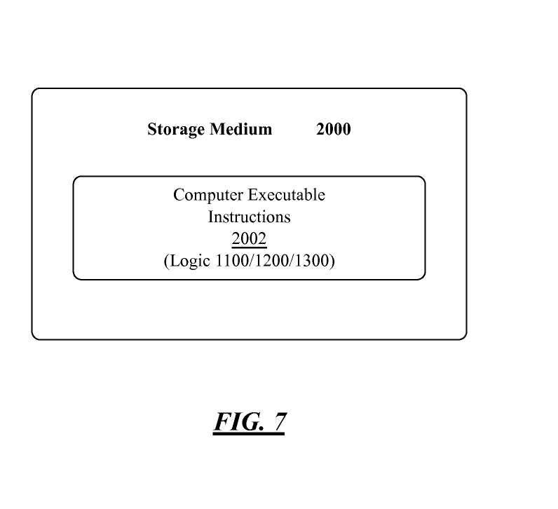

FIG. 7 illustrates an embodiment of a storage medium 2000. The storage medium 2000 may comprise an article of manufacture. In some examples, the storage medium 2000 may include any non-transitory computer readable medium or machine readable medium, such as an optical, magnetic or semiconductor storage. The storage medium 2000 may store various types of computer executable instructions e.g., 2002). For example, the storage medium 2000 may store various types of computer executable instructions to implement logic flow 1100. In some examples, the storage medium 2000 may store various types of computer executable instructions to implement logic flow 1200. In some examples, the storage medium 2000 may store various types of computer executable instructions to implement technique 1300.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

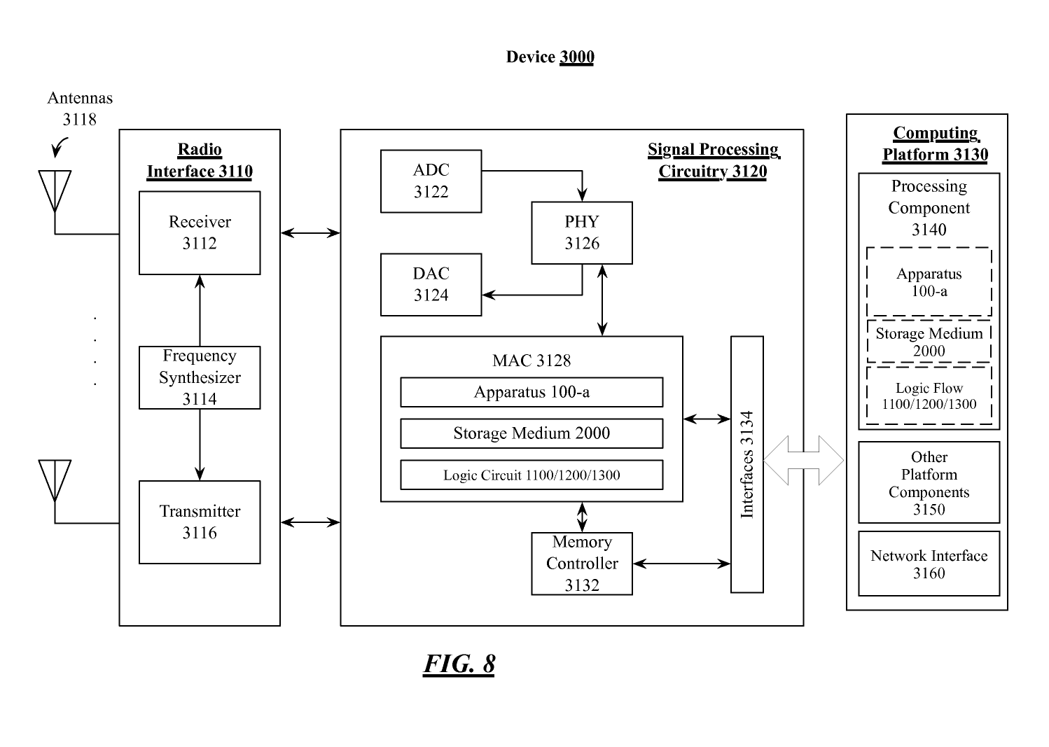

FIG. 8 illustrates an embodiment of a device 3000. In some examples, device 3000 may be configured or arranged for wireless communications in a P2P network such that the P2P network 1000 shown in FIG. 1. In some examples, one of the devices 100-a may be implemented in the device 3000. For example, the device 3000 may implement the device as apparatus 100-a. Additionally, the device 3000 may implement storage medium 2000 and/or a logic circuit 1100/1200/1300. The logic circuits may include physical circuits to perform operations described for the apparatus 100-a, storage medium 2000, logic flow 1100, logic flow 1200, and/or logic flow 1300. As shown in FIG. 8, device 3000 may include a radio interface 3110, baseband circuitry 3120, and computing platform 3130, although examples are not limited to this configuration.

The device 3000 may implement some or all of the structure and/or operations for the apparatus 100-a, the storage medium 2000 and/or the logic circuit 1100/1200/1300 in a single computing entity, such as entirely within a single device. The embodiments are not limited in this context.

Radio interface 3110 may include a component or combination of components adapted for transmitting and/or receiving single carrier or multi-carrier modulated signals (e.g., including complementary code keying (CCK) and/or orthogonal frequency division multiplexing (OFDM) symbols and/or single carrier frequency division multiplexing (SC-FDM symbols) although the embodiments are not limited to any specific over-the-air interface or modulation scheme. Radio interface 3110 may include, for example, a receiver 3112, a transmitter 3116 and/or a frequency synthesizer 3114. Radio interface 3110 may include bias controls, a crystal oscillator and antennas 3118-1 to 3118-f. In another embodiment, radio interface 3110 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 3120 may communicate with radio interface 3110 to process receive and/or transmit signals and may include, for example, an analog-to-digital converter 3122 for down converting received signals, a digital-to-analog converter 3124 for up converting signals for transmission. Further, baseband circuitry 3120 may include a baseband or physical layer (PHY) processing circuit 3126 for PHY link layer processing of respective receive/transmit signals. Baseband circuitry 3120 may include, for example, a processing circuit 3128 for medium access control (MAC)/data link layer processing. Baseband circuitry 3120 may include a memory controller 3132 for communicating with MAC processing circuit 3128 and/or a computing platform 3130, for example, via one or more interfaces 3134.

In some embodiments, PHY processing circuit 3126 may include a frame construction and/or detection module, in combination with additional circuitry such as a buffer memory, to construct and/or deconstruct communication frames (e.g., containing subframes). Alternatively or in addition, MAC processing circuit 3128 may share processing for certain of these functions or perform these processes independent of PHY processing circuit 3126. In some embodiments, MAC and PHY processing may be integrated into a single circuit.

Computing platform 3130 may provide computing functionality for device 3000. As shown, computing platform 3130 may include a processing component 3140. In addition to, or alternatively of, baseband circuitry 3120 of device 3000 may execute processing operations or logic for the apparatus 100a, storage medium 2000, and logic circuits 1100/1200/1300 using the processing component 3130. Processing component 3140 (and/or PHY 3126 and/or MAC 3128) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Computing platform 3130 may further include other platform components 3150. Other platform components 3150 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Computing platform 3130 may further include a network interface 3160. In some examples, network interface 3160 may include logic and/or features to support network interfaces operated in compliance with one or more wireless broadband technologies such as those described in one or more standards associated with IEEE 802.11 such as IEEE 802.11u or with technical specification such as WFA Hotspot 2.0.

Device 3000 may be part of a device in a P2P network and may be included in various types of computing devices to include, but not limited to, user equipment, a computer, a personal computer (PC), a desktop computer, a laptop computer, a notebook computer, a netbook computer, a tablet computer, an ultra-book computer, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of device 2000 described herein; may be included or omitted in various embodiments of device 2000, as suitably desired. In some embodiments, device 2000 may be configured to be compatible with protocols and frequencies associated with IEEE 802.11 Standards or Specification and/or 3GPP Standards or Specifications for MIMO systems, although the examples are not limited in this respect.

The components and features of device 3000 may be implemented using any combination of discrete circuitry, application specific integrated circuits (ASICs), logic gates and/or single chip architectures. Further, the features of device 3000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 3000 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

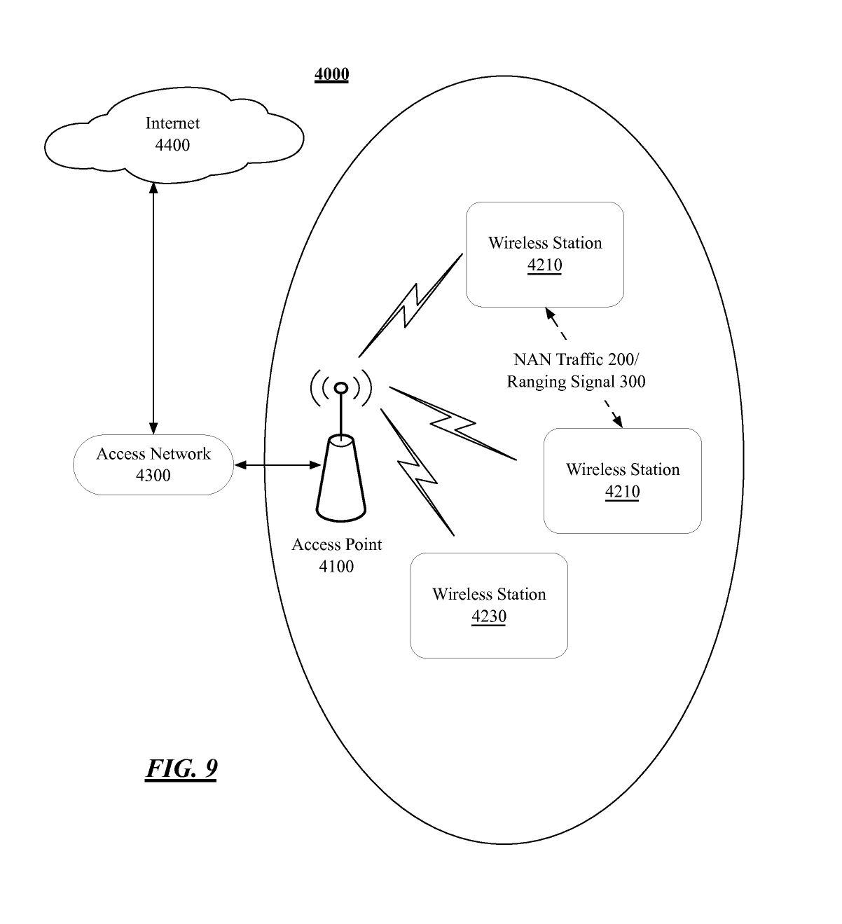

FIG. 9 illustrates an embodiment of a wireless network 4000. As shown in FIG. 7, wireless network 4000 comprises an access point 4100 and wireless stations 4210, 4220, and 4230. In various embodiments, wireless network 4000 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 4000 may comprise another type of wireless network, and/or may implement other wireless communications standards. In various embodiments, for example, wireless network 4000 may comprise a WWAN or WPAN rather than a WLAN. The embodiments are not limited to this example.

In some embodiments, wireless network 4000 may implement one or more broadband wireless communications standards, such as 3G or 4G standards, including their revisions, progeny, and variants. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The embodiments are not limited in this context.

In various embodiments, wireless stations 4210, 4220, and 4230 may communicate with access point 4100 in order to obtain connectivity to one or more external data networks. In some embodiments, for example, wireless stations 4210, 4220, and 4230 may connect to the Internet 4400 via access point 4100 and access network 4300. In various embodiments, access network 4300 may comprise a private network that provides subscription-based Internet-connectivity, such as an Internet Service Provider (ISP) network. The embodiments are not limited to this example.

In various embodiments, two or more of wireless stations 4210, 4220, and 4230 may communicate with each other directly by exchanging peer-to-peer communications. For example, as depicted in FIG. 9, wireless stations 4210 and 4220 communicate with each other directly by exchanging peer-to-peer communications 4500. In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WFDS) Task Group. In various embodiments, such peer-to-peer communications may be performed according to the MFA NAN protocol. The embodiments are not limited to these examples.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose might be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

The disclosure now turns to providing various example implementations. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### Example 1

An apparatus for a device in a neighbor awareness networking (NAN) wireless network, the apparatus comprising: circuitry; a service discovery component executable by the circuitry, the service discovery component to receive a service discovery frame (SDF), the SDF to include an indication of a ranging protocol.

### Example 2

The apparatus of example 1, the SDF to include an indication of a ranging mode of the ranging protocol.

### Example 3

The apparatus of example 1, the SDF to include an indication of an operational environment of the ranging protocol.

### Example 4

The apparatus of example 1, comprising a radio operably coupled to the circuitry, the service discovery component to receive the SDF via the radio.

### Example 5

The apparatus of example 4, wherein the radio comprises a Wi-Fi radio.

### Example 6

The apparatus of example 4, further comprising an antenna operably coupled to the radio.

### Example 7

The apparatus of example 4, further comprising an antenna array operably coupled to the radio.

### Example 8

The apparatus example 1, the circuitry to comprise an application processor or a baseband processor.

### Example 9

The apparatus of example 1, wherein the SDF comprises an indication of connection capabilities and services advertised or solicited within a NAN cluster.

### Example 10

The apparatus of any one of examples 1 to 9, wherein the ranging protocol comprises NAN mode, Wi-Fi direct (WFD) mode, infrastructure mode, or independent basic service set (IBSS) mode.

### Example 11

The apparatus of any one of examples 1 to 9, wherein the SDF comprises a publish SDF or a subscribe SDF.

### Example 12

The apparatus of example 11, wherein the indication of the ranging protocol is comprised in protocol profile field portion of the subscribe SDF or the publish SDF.

### Example 13

An apparatus for a device in a neighbor awareness networking (NAN) wireless network, the apparatus comprising: circuitry; a service discovery component executable by the circuitry, the service discovery component to determine a ranging protocol and to generate a service discovery frame (SDF), the SDF to include an indication of the ranging protocol.

### Example 14

The apparatus of example 13, the SDF to include an indication of a ranging mode of the ranging protocol.

### Example 15

The apparatus of example 13, the SDF to include an indication of an operational environment of the ranging protocol.

### Example 16

The apparatus of example 13, comprising a radio operably coupled to the circuitry, the service discovery component to transmit the SDF via the radio.

### Example 17

The apparatus of example 16, wherein the radio comprises a Wi-Fi radio.

### Example 18

The apparatus of example 16, further comprising an antenna operably coupled to the radio.

### Example 19

The apparatus of example 16, further comprising an antenna array operably coupled to the radio.

### Example 20

The apparatus example 13, the circuitry to comprise an application processor or a baseband processor.

### Example 21

The apparatus of example 13, wherein the SDF comprises an indication of connection capabilities and services advertised or solicited within a NAN cluster.

### Example 22

The apparatus of any one of examples 13 to 21, wherein the ranging protocol comprises NAN mode, Wi-Fi direct (WFD) mode, infrastructure mode, or independent basic service set (IBSS) mode.

### Example 23

The apparatus of any one of examples 13 to 21, wherein the SDF comprises a publish SDF or a subscribe SDF.

### Example 24

The apparatus of example 23, wherein the indication of the ranging protocol is comprised in protocol profile field portion of the subscribe SDF or the publish SDF.

### Example 25

A method implemented by a device in a neighbor awareness networking (NAN) cluster), the method comprising: receiving, via a radio, a service discovery frame (SDF), the SDF to include an indication of a ranging protocol.

### Example 26

The method of example 25, comprising generating a control directive to cause circuitry to initiate a ranging operation based on the ranging protocol.

### Example 27

The method of example 26, wherein the circuitry is operably coupled to the radio.

### Example 28

The method of example 25, the SDF to include an indication of a ranging mode of the ranging protocol.

### Example 29

The method of example 25, the SDF to include an indication of an operational environment of the ranging protocol.

### Example 30

The method of example 25, wherein the radio comprises a Wi-Fi radio.

### Example 31

The method of example 25, wherein the SDF comprises an indication of connection capabilities and services advertised or solicited within a NAN cluster.

### Example 32

The method of any one of examples 25 to 31, wherein the ranging protocol comprises NAN mode, Wi-Fi direct (WFD) mode, infrastructure mode, or independent basic service set (IBSS) mode.

### Example 33

The method of any one of examples 25 to 31, wherein the SDF comprises a publish SDF or a subscribe SDF.

### Example 34

The method of example 33, wherein the indication of the ranging protocol is comprised in a protocol profile field portion of the subscribe SDF or the publish SDF.

### Example 35

A method implemented by a device in a neighbor awareness networking (NAN) cluster), the method comprising: determining a ranging protocol; and generating a service discovery frame (SDF) for transmission via a radio, the SDF to include an indication of the ranging protocol.

### Example 36

The method of example 35, the SDF to include an indication of a ranging mode of the ranging protocol.

### Example 37

The method of example 35, the SDF to include an indication of an operational environment of the ranging protocol.

### Example 38

The method of example 35, wherein the radio comprises a Wi-Fi radio.

### Example 39

The method of example 35, wherein the SDF comprises an indication of connection capabilities and services advertised or solicited within a NAN cluster.

### Example 40

The method of any one of examples 35 to 39, wherein the ranging protocol comprises NAN mode, Wi-Fi direct (WFD) mode, infrastructure mode, or independent basic service set (IBSS) mode.

### Example 41

The method of any one of examples 35 to 39, wherein the SDF comprises a publish SDF or a subscribe SDF.

### Example 42

The method of example 41, wherein the indication of the ranging protocol is comprised in protocol profile field portion of the subscribe SDF or the publish SDF.

### Example 43

An apparatus for a device in a wireless network, the apparatus comprising means to perform the method of any of examples 25 to 42.

### Example 44

At least one machine readable medium comprising a plurality of instructions that in response to being executed by circuitry on a device in a neighbor awareness networking (NAN) cluster cause the device to perform the method of any of examples 25 to 42.

### Example 45

An apparatus for a wireless network comprising: a processor; a radio operably connected to the processor; one or more antennas operably connected to the radio to transmit or receive wireless signals; and a memory comprising a plurality of instructions that in response to being executed by the processor cause the processor or the radio to perform the method of any of examples 25 to 42.

1. An apparatus for a device in a neighbor awareness networking (NAN) wireless network, the apparatus comprising:
circuitry;
a service discovery component executable by the circuitry, the service discovery component to receive a service discovery frame (SDF), the SDF to include an indication of a ranging protocol.

2. The apparatus of claim 1, the SDF to include an indication of a ranging mode of the ranging protocol.

3. The apparatus of claim 1, the SDF to include an indication of an operational environment of the ranging protocol.

4. The apparatus of claim 1, comprising a radio operably coupled to the circuitry, the service discovery component to receive the SDF via the radio.

5. The apparatus of claim 4, wherein the radio comprises a Wi-Fi radio.

6. The apparatus of claim 4, further comprising an antenna operably coupled to the radio.

7. The apparatus of claim 4, further comprising an antenna array operably coupled to the radio.

8. The apparatus claim 1, the circuitry to comprise an application processor or a baseband processor.

9. The apparatus of claim 1, wherein the SDF comprises an indication of connection capabilities and services advertised or solicited within a NAN cluster.

10. The apparatus claim 1, wherein the ranging protocol comprises NAN mode, Wi-Fi direct (WFD) mode, infrastructure mode, or independent basic service set (IBSS) mode.

11. The apparatus of claim 1, wherein the SDF comprises a publish SDF or a subscribe SDF.

12. The apparatus of claim 11, wherein the indication of the ranging protocol is comprised in protocol profile field portion of the subscribe SDF or the publish SDF.

13. An apparatus for a device in a neighbor awareness networking (NAN) wireless network, the apparatus comprising:
circuitry;
a service discovery component executable by the circuitry, the service discovery component to determine a ranging protocol and to generate a service discovery frame (SDF), the SDF to include an indication of the ranging protocol.

14. The apparatus of claim 13, the SDF to include an indication of a ranging mode of the ranging protocol.

15. The apparatus of claim 13, the SDF to include an indication of an operational environment of the ranging protocol.

16. The apparatus of claim 13, wherein the ranging protocol comprises NAN mode, Wi-Fi direct (WFD) mode, infrastructure mode, or independent basic service set (IBSS) mode.

17. The apparatus of claim 13, wherein the SDF comprises a publish SDF or a subscribe SDF.

18. A method implemented by a device in a neighbor awareness networking (NAN) cluster), the method comprising:
receiving, via a radio, a service discovery frame (SDF), the SDF to include an indication of a ranging protocol; and
generating a control directive to cause circuitry to initiate a ranging operation based on the ranging protocol.

19. The method of claim 18, the SDF to include an indication of a ranging mode of the ranging protocol.

20. The method of claim 18, the SDF to include an indication of an operational environment of the ranging protocol.

21. The method of claim 18, wherein the SDF comprises a publish SDF or a subscribe SDF and wherein the indication of the ranging protocol is comprised in a protocol profile field portion of the subscribe SDF or the publish SDF.

22. At least one machine readable medium comprising a plurality of instructions that in response to being executed by circuitry on a device in a neighbor awareness networking (NAN) cluster cause the device to:
determine a ranging protocol; and
generate a service discovery frame (SDF) for transmission via a radio, the SDF to include an indication of the ranging protocol.

23. The at least one machine readable medium of claim 22, the SDF to include an indication of a ranging mode of the ranging protocol.

24. The at least one machine readable medium of claim 22, the SDF to include an indication of an operational environment of the ranging protocol.

25. The at least one machine readable medium of claim 22, wherein the ranging protocol comprises NAN mode, Wi-Fi direct (WFD) mode, infrastructure mode, or independent basic service set (IBSS) mode.
